(19) United States
(12) Patent Application Publication
(10) Pub. No.: US 2020/0189569 A1
(43) Pub. Date: Jun. 18, 2020

(54) DRIVER VERIFIED SELF PARKING

(71) Applicant: Ford Global Technologies, LLC, Dearborn, MI (US)

(72) Inventors: Muhammad Adeel AWAN, Dearborn, MI (US); Ahmed MIMOUN, Dearborn, MI (US); Mohamed BENMIMOUN, Dearborn, MI (US); Mohsen LAKEHAL-AYAT, Dearborn, MI (US)

(21) Appl. No.: 16/609,032

(22) PCT Filed: Apr. 27, 2017
(86) PCT No.: PCT/US2017/029926

§ 371 Date: Oct. 28, 2019

(51) Int. Cl. B60W 30/06; B62D 15/02; B62D 1/00; G06K 9/00; H04W 4/80

(52) U.S. Cl. CPC B60W 30/06; B62D 15/0285; B62D 15/0265; B60W 2050/0002; G06K 9/00805; H04W 4/80; B62D 1/00

(57) ABSTRACT

A controller for an autonomous vehicle detects movement of a bezel on a smartwatch or other wearable device with wireless communication capabilities. A driver initiates a parking maneuver. The controller executes the parking maneuver only so long as movement of the bezel is detected in order to ensure that the driver is present and engaged. If movement of the bezel ceases, the controller will pause the parking maneuver. In some embodiments, direction of rotation of the bezel will determine whether the vehicle moves forward or in reverse in to a parking spot.

### BACKGROUND

### Field of the Invention

This invention relates to self-parking vehicles.

### Background of the Invention

Most current auto-parking solutions require the driver to be present inside the vehicle with the possibility of having the driver engage the accelerator and brake controls of the vehicle. Some systems involve the driver standing outside the vehicle but give limited control to the driver to execute the parking maneuver. Parking a vehicle must often be done with tight constraints on available free space, sensor visibility, a temporary parking map, and the like. These constraints make it difficult for auto-parking solutions to be executed reliably in some scenarios such as ‘tight parking spots’ in city centers. Current systems also find it difficult to handle common parking scenarios like parking the vehicle in a cluttered drive-way, parking the vehicle in a garage, and other non-conventional situations.

Some systems require the driver to be engaged throughout the parking process, though not necessarily controlling movement of the vehicle. For example, in some approaches the driver is required to trace a shape, e.g. circle, on a smartphone screen during the parking process in order to indicate that the driver is present and engaged. If the driver ceases to provide the input, the self-parking maneuver is stopped. This approach is impractical in the rain or in cold weather when the driver is wearing gloves.

The systems and methods disclosed herein provide an improved approach for incorporating driver assistance into an auto-parking solution.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system for implementing embodiments of the invention;

FIG. 2 is a schematic block diagram of an example computing device suitable for implementing methods in accordance with embodiments of the invention;

FIG. 3 is a process flow diagram of a method for verifying driver involvement in a parking maneuver in accordance with an embodiment of the present invention;

FIG. 4 is a schematic diagram illustrating an example parking scenario; and

FIG. 5 is a process flow diagram of a method for receiving user selection of a trajectory during a parking maneuver in accordance with an embodiment of the present invention.

### DETAILED DESCRIPTION

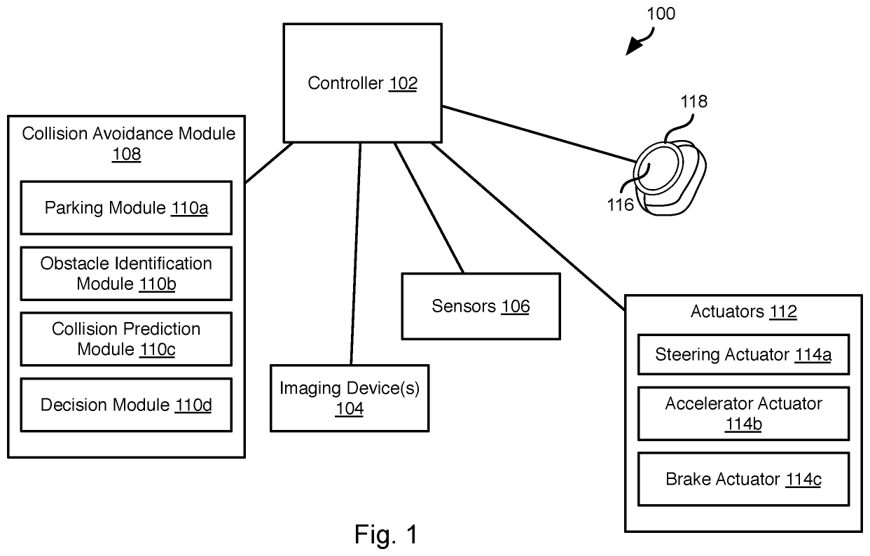

Referring to FIG. 1, a system 100 may include a controller 102 housed within a vehicle. The vehicle may include any vehicle known in the art. The vehicle may have all of the structures and features of any vehicle known in the art including, wheels, a drive train coupled to the wheels, an engine coupled to the drive train, a steering system, a braking system, and other systems known in the art to be included in a vehicle.

As discussed in greater detail herein, the controller 102 may perform autonomous navigation and collision avoidance. In particular, image data, other sensor data, and possibly audio data may be analyzed to identify obstacles.

The controller 102 may receive one or more image streams from one or more imaging devices 104. For example, one or more cameras may be mounted to the vehicle and output image streams received by the controller 102. The controller 102 may also receive outputs from one or more other sensors 106. Sensors 106 may include sensing devices such as RADAR (Radio Detection and Ranging), LIDAR (Light Detection and Ranging), SONAR (Sound Navigation and Ranging), and the like. Sensors 106 may include one or more microphones or microphone arrays providing one or more audio streams to the controller 102. For example, one or more microphones or microphone arrays may be mounted to an exterior of the vehicle. The microphones 106 may include directional microphones having a sensitivity that varies with angle.

The controller 102 may execute a collision avoidance module 108 that receives streams of information from the imaging devices 104 and sensors 106, identifies possible obstacles using the streams of information, and takes measures to avoid them while guiding the vehicle to a desired destination.

The collision avoidance module 108 may include a parking module 110a. The parking module is programmed to identify parking spaces and execute parking maneuvers subject to obstacle avoidance constraints and based on input from a driver as described in greater detail below.

The collision avoidance module 108 may further include an obstacle identification module 110b that analyzes the streams of information from the imaging devices 104 and sensors 106 and identifies potential obstacles, including people, animals, vehicles, buildings, curbs, and other objects and structures.

A collision prediction module 110c predicts which obstacles are likely to collide with the vehicle based on its current trajectory. The collision prediction module 110c may evaluate the likelihood of collision with objects identified by the obstacle identification module 110b.

A decision module 110d may make a decision to follow a current trajectory, stop, accelerate, deviate from the trajectory, etc. in order to avoid obstacles. The manner in which the collision prediction module 110c predicts potential collisions and the manner in which the decision module 110d takes action to avoid potential collisions may be according to any method or system known in the art of autonomous vehicles.

The decision module 110d may control the trajectory of the vehicle by actuating one or more actuators 112 controlling the direction and speed of the vehicle. For example, the actuators 112 may include a steering actuator 114a, an accelerator actuator 114b, and a brake actuator 114c. The configuration of the actuators 114a-114c may be according to any implementation of such actuators known in the art of autonomous vehicles.

A smartwatch 116 of a driver (or other user) may be in data communication with the controller 102, such as by means of BLUETOOTH, WI-FI, ANT+, or some other wireless connection, preferably a short range wireless connection. For example, a BLUETOOTH Low Energy (BLE) connection may be used. The smartwatch 116 may be embodied as smartwatch or other device with wireless communication capabilities having a rotatable bezel 118. For example, the SAMSUNG GEAR S2/S3 is a smartwatch that includes a rotating bezel as an input device. As described below, rotation of a bezel is the only input provided by the user in some implementations. Accordingly, a watch, ring, or other wearable item with a rotating bezel 118 or knob that is able to transmit one or both of detection of rotation and a direction of rotation may be used. Other smartwatch functionality such as the ability to respond to calls, track user movement, display information on a screen, and the like may be omitted.

Although the systems and methods disclosed herein are advantageously implemented with the user outside of the vehicle, the actions ascribed herein to the smartwatch 116 may also be performed by an in-vehicle infotainment (IVI) system coupled to the controller 102. For example, by rotating a knob of the IVI system rather than the bezel 118.

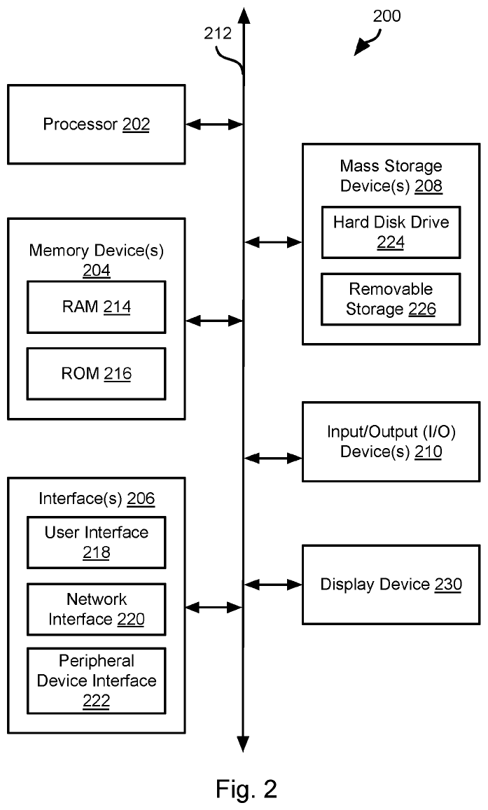

FIG. 2 is a block diagram illustrating an example computing device 200. Computing device 200 may be used to perform various procedures, such as those discussed herein. The controller 102 and smartwatch 116 may have some or all of the attributes of the computing device 200.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

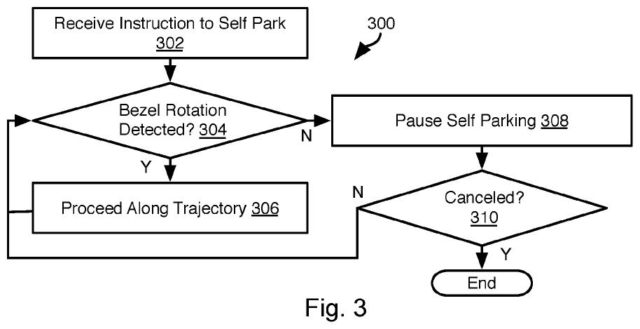

Referring to FIG. 3, the illustrated method 300 may be executed by the controller 102. The method 300 may include receiving 302 an instruction to self-park. The instruction to self-park may be received by way of an input device coupled to the controller 102 or the smartwatch 116. Self-parking may be performed while the driver is located outside of the vehicle. In some embodiments, self-parking will only be performed by the controller 102 while the user is outside of the vehicle. For example, the strength of a wireless signal from the smartwatch 116 (e.g., a BLUETOOTH or BLE signal) may be evaluated to determine whether a distance to the smartwatch 116 is greater than a high threshold value. If not, then self-parking may be suppressed. Likewise, if the signal strength is below a low threshold, indicating too great a distance, self-parking may be suppressed.

The remaining steps of the method 300 may be performed in response to the instruction of step 302. The method 300 may include evaluating 304 whether rotation of the bezel has been detected, e.g. detected within some time window extending prior to the time of performing the evaluation of step 304, e.g. from 0.1 to 2 ms. If so, then the controller 102 causes the vehicle to proceed 306 along a self-parking trajectory. The self-parking trajectory may be determined according to any method known in the art of self-parking vehicles. Step 306 will include detecting obstacles around the vehicle, detecting an open position (or receiving driver selection of an open position), and determining a trajectory that will propel the vehicle to the open position while avoiding obstacles. Step 306 may further include detecting obstacles and movement during movement along the trajectory and adjusting accordingly to avoid collisions.

Step 306 may be performed incrementally and may be periodically interrupted by repeated execution of step 304. Alternatively, step 304 may be executed in parallel with step 306 such that step 306 is interrupted in response to detecting the bezel rotation is not detected 304 within the time window.

If bezel rotation is not detected 304 either prior to initiating proceeding 306 along the trajectory or during proceeding 306 along the trajectory, then the self-parking maneuver may be paused 308. If, following pausing 308, bezel rotation is again detected 304, then processing may continue at step 306 as described above. If, following pausing the driving maneuver is determined 310 to be canceled, then the self-parking maneuver may end and control may be returned to the driver to either take over manual control of the vehicle or again invoke self-parking. Canceling may be detected by detecting a signal from the smartwatch 116 indicating an instruction to cancel or by failing to detect rotation of the bezel 118 for some threshold period, e.g. 2 to 10 seconds.

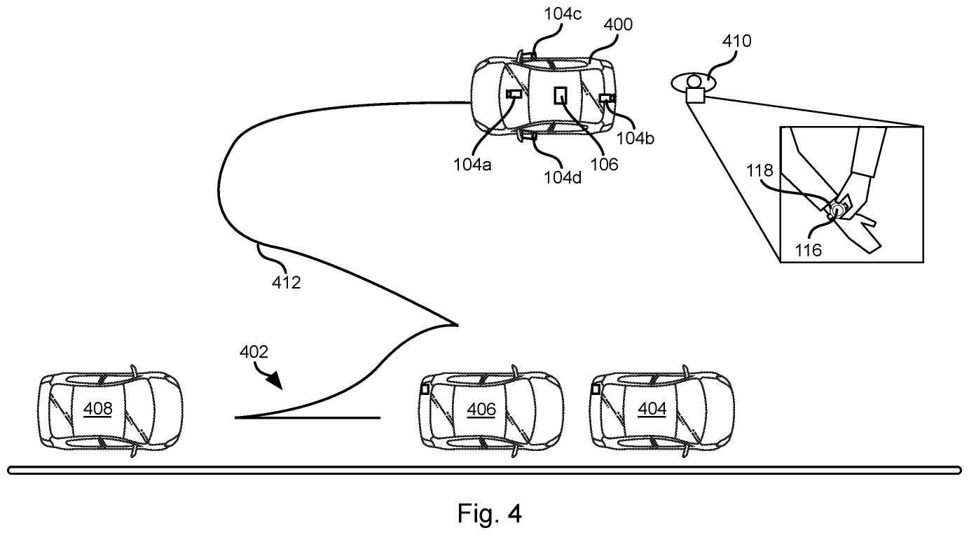

FIG. 4 illustrates an example execution of the method 300. The illustrated example includes a vehicle 400 housing the controller 102. A user may instruct the controller 102 to self-park in parking position 402 among vehicles 404-408, which are obstacles. The vehicle 400 may include a forward facing camera 104a, a rearward facing camera 104b, and may include one or more lateral cameras 104c, 104d. Other sensors 106, such as LIDAR and RADAR sensors are also mounted to the vehicle and have parking position 402 and other vehicles 404-408 in its field of view.

A driver 410 invokes a self-parking maneuver and subsequently rotates the bezel 118 of the smartwatch 116. In response, the controller 102 traverses a trajectory 412 to the parking position 402 that avoids the vehicles 404-408. While traversing the trajectory, the controller 102 continues to monitor for obstacles and adjust the trajectory 412 accordingly, which may include temporarily stopping. Likewise, if the driver stops rotating the bezel 118, the controller 102 will pause traversal of the trajectory 412 until rotation is again detected.

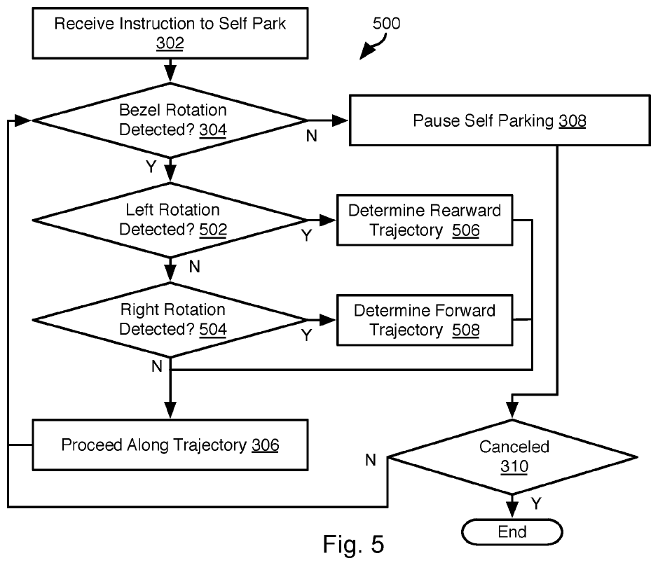

FIG. 5 illustrates an alternative method 500 for controlling an autonomous parking maneuver using a bezel 118 of a smartwatch 116. The method may include receiving 302 and instruction to execute a self-parking maneuver and evaluating 304 whether bezel rotation has been detected. As for the method 300, if no bezel rotation is detected, the self-parking maneuver is paused 308 and may be canceled 310 as described above.

However, if bezel rotation is detected 304, the method 500 may include evaluating 502, 504 whether rotation of the bezel is leftward or rightward. If the direction of rotation is leftward, then the controller 102 determines 506 a rearward trajectory, e.g. a trajectory that directs the vehicle toward an open parking position behind the vehicle or approaches a parking position in the reverse direction. If the direction of rotation is rightward, then the controller 102 determines 508 a forward trajectory, e.g. a trajectory that directs the vehicle toward an open parking position in front the vehicle or approaches a parking position in the forward direction. Of course, the relationship between rightward and leftward rotation and rearward and forward trajectories may be switched, such as according to user preferences.

The method 500 may then include proceeding 306 along the trajectory selected at step 506 or 508 until cessation of rotation of the bezel 118 is detected 304 in the same manner as for the method 300. In some embodiments, direction of rotation is used to determine an initial direction of movement of a parking maneuver, after which change in the direction of rotation will not affect the trajectory. In other embodiments, during a parking maneuver, a driver may invoke change in the direction of the trajectory by changing a direction of rotation of the bezel 118.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s). At least some embodiments of the disclosure have been directed to computer program products comprising such logic (e.g., in the form of software) stored on any computer useable medium. Such software, when executed in one or more data processing devices, causes a device to operate as described herein.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising, using a controller housed in a vehicle:
initiating a self-parking maneuver of the vehicle;
continuing execution of the self-parking maneuver while rotation of a bezel of a smart watch is detected; and
pausing execution of the self-parking maneuver in response to failing to detect rotation of the bezel.

2. The method of claim 1, further comprising pairing the smart watch with the controller according to a wireless protocol prior to initiating the self-parking maneuver of the vehicle.

3. The method of claim 2, wherein the wireless protocol is a short-range wireless protocol.

4. The method of claim 3, wherein the short-range wireless protocol is BLUETOOTH.

5. The method of claim 1, further comprising initiating movement of the vehicle to execute the self-parking maneuver only upon detecting movement of the bezel.

6. The method of claim 1, further comprising:
receiving, by the controller, outputs of one or more sensors mounted to the vehicle;
identifying, by the controller, obstacles around the vehicle using the outputs of the one or more sensors;
generating, by the controller, a trajectory to a parking spot that avoids the obstacles; and
traversing the trajectory while rotation of the bezel is detected.

7. The method of claim 6, wherein the one or more sensors include at least one of a camera, a light distancing and ranging (LIDAR) sensor, and a radio distance and ranging (RADAR) sensor.

8. The method of claim 6, wherein the vehicle comprises an accelerator actuator, steering actuator, and brake actuator, the method further comprises executing the self-parking maneuver while rotation of the bezel is detected by activating one or more of the accelerator actuator, steering actuator, and brake actuator.

9. The method of claim 6, further comprising selecting a direction of the trajectory according to a direction of rotation of the bezel.

10. The method of claim 1, wherein the smartwatch is located outside of the vehicle during execution of the self-parking maneuver.

11. A system comprising:
a vehicle;
a controller housed in the vehicle and comprising a processing device programmed to:
initiate a self-parking maneuver of the vehicle in response to a driver instruction;
if rotation of a bezel of a smart watch is detected following receipt of the driver instruction, continuing execution of the self-parking maneuver;
if rotation of the bezel is not detected following receipt of the driver instruction and prior to completion of the self-parking maneuver, pausing execution of the self-parking maneuver.

12. The system of claim 11, wherein the controller is further programmed to pair with the smart watch according to a wireless protocol prior to initiating the self-parking maneuver of the vehicle.

13. The system of claim 12, wherein the wireless protocol is a short-range wireless protocol.

14. The system of claim 13, wherein the short-range wireless protocol is BLUETOOTH.

15. The system of claim 11, wherein the controller is further programmed to initiate movement of the vehicle to execute the parking maneuver only upon detecting movement of the bezel.

16. The system of claim 11, further comprising one or more sensors mounted to the vehicle;
wherein the controller is further programmed to:
receive outputs of one or more sensors mounted to the vehicle;
identify obstacles around the vehicle using the outputs of the one or more sensors;
generate a trajectory to a parking spot that avoids the obstacles; and
traverse the trajectory while rotation of the bezel is detected.

17. The system of claim 16, wherein the one or more sensors include at least one of a camera, a light distancing and ranging (LIDAR) sensor, and a radio distance and ranging (RADAR) sensor.

18. The system of claim 16, wherein the vehicle further comprises an accelerator actuator, steering actuator, and brake actuator; and
wherein the controller is further programmed to execute the self-parking maneuver while rotation of the bezel is detected by activating one or more of the accelerator actuator, steering actuator, and brake actuator.

19. The system of claim 16, wherein the controller is further programmed to select a direction of the trajectory according to a direction of rotation of the bezel.

20. The system of claim 11, further comprising the smartwatch located outside of the vehicle during execution of the self-parking maneuver.
